(19) United States
(12) Patent Application Publication
(10) Pub. No.: US 2025/0056628 A1
(43) Pub. Date: Feb. 13, 2025

(54) HANDOVER

(71) Applicant: Nokia Technologies Oy, Espoo (FI)

(72) Inventors: Shehzad Ali ASHRAF, Munich (DE); Panagiotis SPAPIS, Munich (DE); Umur KARABULUT, Munich (DE); Srinivasan SELVAGANAPATHY, Bangalore (IN)

(21) Appl. No.: 18/790,344

(22) Filed: Jul. 31, 2024

(30) Foreign Application Priority Data
Aug. 10, 2023 (IN) 202341053793

(51) Int. Cl. H04W 74/0838

(52) U.S. Cl. CPC H04W 74/0838

(57) ABSTRACT

An apparatus (DU) comprising: means for receiving an identification of a serving network access node; and means for associating a sub-set of contention-free-random-access (CFRA) resources with the identified serving network access node. An apparatus (CU) comprising: means for sending a first message comprising an identification of a serving network access node (sDU) to enable association of a sub-set of contention-free-random-access (CFRA) resources with the identified serving network access node (sDU); and means for receiving, in reply, a second message specifying the association of the sub-set of contention-free-random-access (CFRA) resources with the identified serving network access node (sDU).

### TECHNOLOGICAL FIELD

Examples of the disclosure relate to contention free random access. Some relate to using contention free random access for handover between cells controlled by different distributed units.

### BACKGROUND

Handover transfers an ongoing communication session of a user equipment (UE) from one cell to another cell in connected state. Handover is used to provide continuity of service for the user, especially while the user is on the move.

Historically cell level mobility has been configured at layer-3 (e.g. radio resource control RRC). The network controls UE mobility based on UE measurement reporting. The trigger for completing handover can be the network, or with conditional handover, the user equipment. Conditional handover is executed by the user equipment only when a network configured execution condition is met. The handover decision is made on layer 3 measurements.

Dual Active Protocol Stack (DAPS) handover allows a user equipment to initiate a handover to a target cell while maintaining the connection with the source cell by activating two protocol stacks, one for the source cell and the other for the target cell.

Lower layer triggered mobility (LTM) enables handover via L1/L2 signaling, while keeping configuration of the upper layers and/or minimizing changes of configuration of the lower layers. The network triggers a LTM cell switch by sending a MAC control element (CE) to the UE.

In contention free random access (CFRA) a dedicated CFRA resource is configured per UE and this resource is unique i.e., no other UE can use this resource. This has an advantage that there is no possibility of collision when sending a preamble, based on the dedicated CFRA resource, over PRACH. The CFRA resource needs to be uniquely configured per UE (i.e., multiple UEs cannot share the resources) which may result in resource scarcity, especially in dense urban deployments.

### BRIEF SUMMARY

According to various, but not necessarily all, examples there is provided examples as claimed in the appended claims.

While the above examples of the disclosure and optional features are described separately, it is to be understood that their provision in all possible combinations and permutations is contained within the disclosure. It is to be understood that various examples of the disclosure can comprise any or all of the features described in respect of other examples of the disclosure, and vice versa. Also, it is to be appreciated that any one or more or all of the features, in any combination, may be implemented by/comprised in/performable by an apparatus, a method, and/or computer program instructions as desired, and as appropriate.

### BRIEF DESCRIPTION

Some examples will now be described with reference to the accompanying drawings in which:

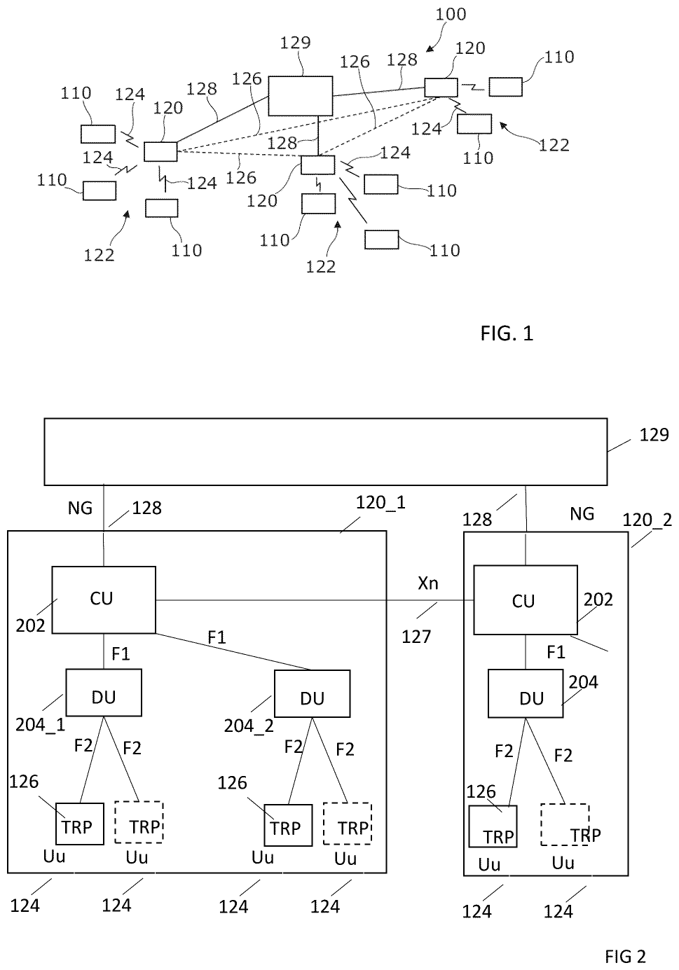

FIGS. 1 to 13 show examples of the subject matter described herein.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Similar reference numerals are used in the figures to designate similar features. For clarity, all reference numerals are not necessarily displayed in all figures.

In the following description a class (or set) can be referenced using a reference number without a subscript index (e.g. 10) and a specific instance of the class (member of the set) can be referenced using the reference number with a numerical type subscript index (e.g. 10_1) and a non-specific instance of the class (member of the set) can be referenced using the reference number with a variable type subscript index (e.g. 10_i).

### DETAILED DESCRIPTION

The following relates to an apparatus comprising:
means 305 for receiving an identification 304 of a serving network access node; and
means 306 for associating a sub-set 604 of contention-free-random-access (CFRA) resources 602 with the identified serving network access node. In some but not necessarily all examples, this apparatus is a network access node, for example a network node that is not serving a user equipment (UE) served by the serving network access node. In some but not necessarily all examples, the apparatus is distributed unit, for example a target distributed unit (tDU) 204_2 that is a target for UE handover from the serving network access node to the target distributed unit. The serving network access node can be a distributed unit.

The following relates to an apparatus comprising:
means 303 for sending a first message 302 comprising an identification 304 of a serving network access node to enable association of a sub-set 604 of contention-free-random-access (CFRA) resources 602 with the identified serving network access node; and
means 307 for receiving, in reply, a second message 321 specifying the association of the sub-set 604 of contention-free-random-access (CFRA) resources 602 with the identified serving network access node. In some but not necessarily all examples, this apparatus is a central unit (CU). For example a central unit controlling the serving network access node as a distributed unit (sDU) and/or controlling a target distributed unit (tDU) that is a target for UE handover from the serving network access node (sDU) to the target distributed unit (tDU).

The term ‘target’ and ‘candidate’ as applied to a distributed unit or network access node, are interchangeable.

FIG. 1 illustrates an example of a network 100 comprising a plurality of network nodes including terminal nodes 110, access nodes 120 and one or more core nodes 129. The terminal nodes 110 and access nodes 120 communicate with each other. The one or more core nodes 129 communicate with the access nodes 120.

The network 100 is in this example a radio telecommunications network, in which at least some of the terminal nodes 110 and access nodes 120 communicate with each other using transmission/reception of radio waves.

The one or more core nodes 129 may, in some examples, communicate with each other. The one or more access nodes 120 may, in some examples, communicate with each other.

The network 100 may be a cellular network comprising a plurality of cells 122 each served by an access node 120. In this example, the interface between the terminal nodes 110 and an access node 120 defining a cell 122 is a wireless interface 124.

The access node 120 is a cellular radio transceiver. The terminal nodes 110 are cellular radio transceivers.

In the example illustrated the cellular network 100 is a third generation Partnership Project (3GPP) network in which the terminal nodes 110 are user equipment (UE) and the access nodes 120 are base stations.

In the example illustrated the network 100 is an Evolved Universal Terrestrial Radio Access network (E-UTRAN). The E-UTRAN consists of E-UTRAN NodeBs (eNBs) 120, providing the E-UTRA user plane and control plane (RRC) protocol terminations towards the UE 110. The eNBs 120 are interconnected with each other by means of an X2 interface 126. The eNBs are also connected by means of the S1 interface 128 to the Mobility Management Entity (MME) 129.

In other example the network 100 is a Next Generation (or New Radio, NR) Radio Access network (NG-RAN). The NG-RAN consists of gNodeBs (gNBs) 120, providing the user plane and control plane (RRC) protocol terminations towards the UE 110. The gNBs 120 are interconnected with each other by means of an X2/Xn interface 126. The gNBs are also connected by means of the N2 interface 128 to the Access and Mobility management Function (AMF).

A user equipment comprises a mobile equipment. Where reference is made to user equipment that reference includes and encompasses, wherever possible, a reference to mobile equipment.

FIG. 2 illustrates a network according to a current 3GPP specification. The network is hierarchical. It comprises a core 129 and radio access nodes 120. The core 129 connects to the radio access nodes 120 via the interface 128 (NG Interface). The radio access nodes 120 connect to user equipment via the air interface 124 (Uu). The radio access nodes 120 connect to other radio access nodes 120 via the interface 126 (Xn interface).

In this example, one or more of the radio access nodes 120 is logically split into a central unit (CU) 202 and one or more distributed units (DU) 204. A DU 204 uses one or more transmission reception points (TRP) 126.

The CU 202 controls the operation of one or more DUs 204. The CU 202 terminates the F1 interface connected with a DU 204. The CU 202 hosts higher layer protocols e.g. at least radio resource control (RRC) protocol layer and packet data convergence protocol (PDCP) protocol layer.

A DU 204 is partly controlled by a CU 202. One DU 204 supports one or multiple radio transmission points 126. One TRP 126 is supported by only one DU 204. The DU 204 terminates the F1 interface connected with the CU 202. The DU 204 hosts lower layer protocols e.g. radio link control (RLC) protocol layer, medium access control (MAC) protocol later and physical (PHY) protocol layer. The DU 204 may communicate via the dedicated interface (e.g. an F1 interface) to a RRC layer hosted by the CU 302.

The interface 127 supports the exchange of information between the CUs 202 of two different radio access nodes 120. The interface 127 enables the inter-connection of radio access nodes 120 supplied by different manufacturers. In at least some examples, data exchange over the interface 127 is between two radio access nodes 120 that belongs to the same operator or between operators with agreements.

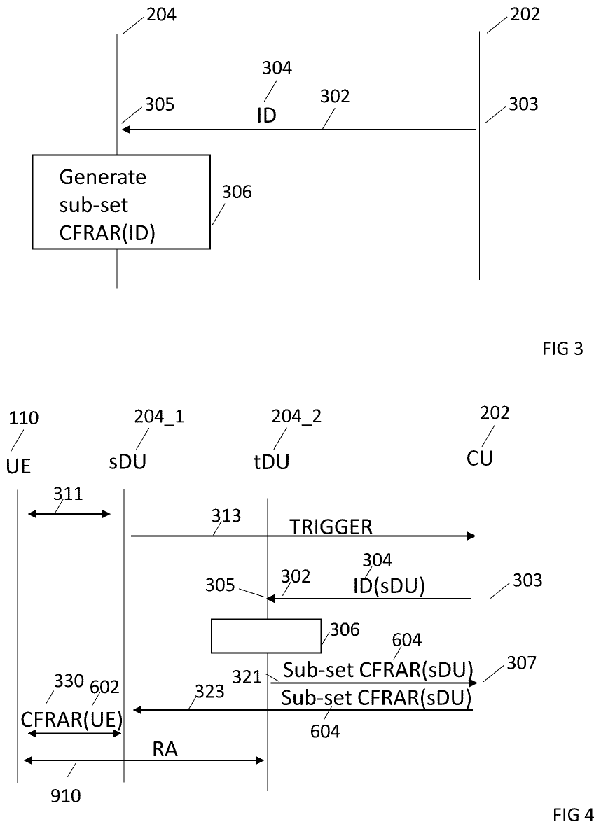

FIG. 3 illustrates an example of an apparatus 204 comprising:
means 305 for receiving an identification 304 of a serving network access node; and
means 306 for associating a sub-set of contention-free-random-access (CFRA) resources with the identified serving network access node.

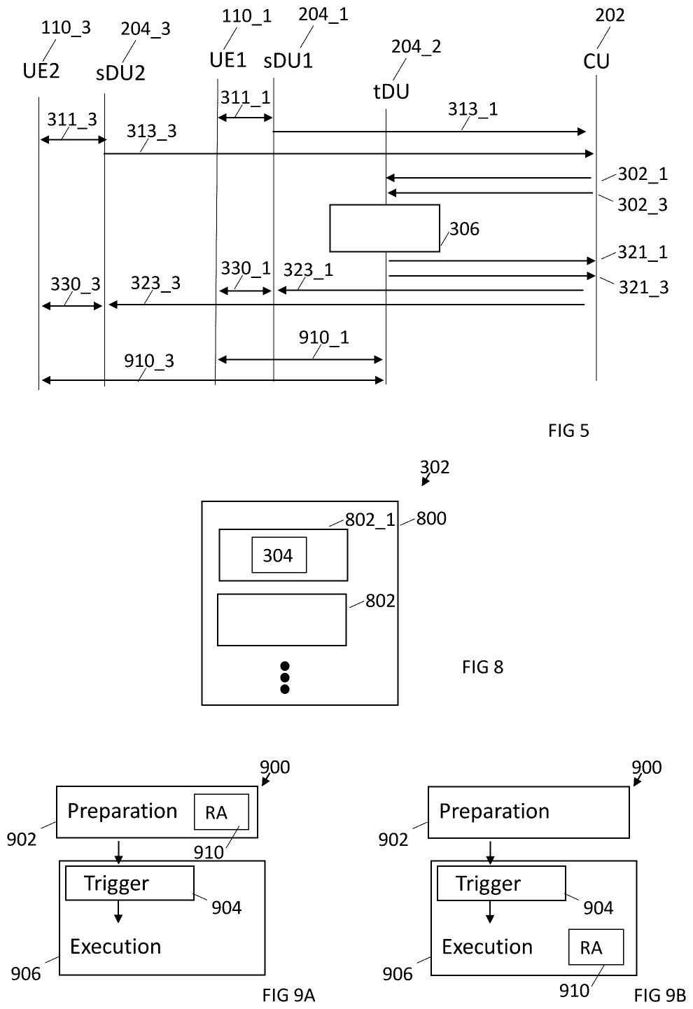

Referring to FIG. 4, in some but not necessarily all examples, this apparatus 204 is a network access node, for example a network node that is not serving a user equipment (UE) served by the serving network access node. In some but not necessarily all examples, the apparatus 204 is distributed unit (DU), for example a target distributed unit (tDU) that is a target for UE handover from the serving network access node to the target distributed unit (tDU). The serving network access node can be a distributed unit (sDU).

FIG. 3 also illustrates an example of an apparatus 202 comprising:
means 303 for sending a first message 302 comprising an identification 304 of a serving network access node to enable association of a sub-set of contention-free-random-access (CFRA) resources with the identified serving network access node; and
means 307 for receiving, in reply, a second message 321 specifying the association of the sub-set of contention-free-random-access (CFRA) resources with the identified serving network access node.

Referring to FIG. 4, in some but not necessarily all examples, this apparatus 202 is a central unit (CU). For example a central unit controlling the serving network access node as a distributed unit (sDU) and/or controlling a target distributed unit (tDU) that is a target for UE handover from the serving network access node (sDU) to the target distributed unit (tDU).

A CFRA resource can, for example, comprise a random-access preamble used by the UE to perform a random access to a target network access node not serving the user equipment. A CFRA resource can, for example, be constrained in time. A CFRA resource can, for example, comprise a random-access preamble on one or more occasions for performing a random access to the target network access node. A CFRA resource can, for example, be additionally or alternatively constrained in space. A CFRA resource can, for example, comprise a random-access preamble for a particular beam, for example a reception beam at the target network access node.

In some examples, a CFRA resource is a random-access preamble on a particular Random Access Channel (RACH) occasion for a particular beam. The CFRA resource can, for example, be determined by a combination of preamble index, Physical Random Access Channel (PRACH) mask index indicating RACH occasion and/or synchronization signal (SS)/Physical Broadcast Channel (PBCH) index.

FIG. 4 illustrates an example of a distributed unit 204_2 that is operating as a target distributed unit (tDU). A target distributed unit (tDU) is a target of a handover of a user equipment.

The distributed unit 204_1 is operating as a serving distributed unit (sDU) for a user equipment 110 and is serving the user equipment (UE) 110. The UE 110 is connected to a cell controlled by the serving distributed unit (sDU) 204_1.

The distributed unit 204_2 is not operating as a serving distributed unit (sDU) for the UE 110 and is not serving the user equipment (UE) 110. The UE 110 is not connected to a cell controlled by the serving distributed unit (sDU) 204_1.

The UE 110 can change serving cells. For example, it can change from being connected to a cell controlled by the distributed unit 204_1 to being connected to a cell controlled by the distributed unit 204_2. This can be referred to as handover between the distributed units 204_1, 204_2. The serving distributed unit (sDU) for the UE 110 changes from the DU 204_1 to the DU 204_2.

To connect to the cell controlled by the distributed unit 204_1 (by handover or otherwise) a random access is performed by the UE 110 towards a target distribution unit (tDU) which in this case is the distributed unit 204_1. This random access requires use of a CFRA resource, if the random access is to be contention free.

A distribution unit (DU) can, for example, comprising means for enabling it to operate as a target distribution unit (tDU) for one UE and as a serving distribution unit for another UE.

A distribution unit can 204, for example, comprising means for enabling it to operate as a target distribution unit (tDU). The distribution unit 204_2 is operating as a target distribution unit (tDU) in FIG. 4 and comprises:
means 305 for receiving an identification 304 of a serving network access node 204_1; and
means 306 for associating a sub-set of contention-free-random-access (CFRA) resources with the identified serving network access node 204_1.

The serving network access node 204_1 is a serving distributing unit (sDU).

The means 305 for receiving the identification of the serving network access node is configured, in this example, to receive the identification of the serving network access node 204_1 from the central unit (CU) 202 of the radio access network.

The central unit (CU) 202 comprises:
means 303 for sending a first message 302 comprising an identification 304 of a serving network access node to enable association of a sub-set of contention-free-random-access (CFRA) resources with the identified serving network access node 204_1; and
means 307 for receiving, in reply, a second message 321 specifying the association of the sub-set of contention-free-random-access (CFRA) resources with the identified serving network access node 204_1.

The means 303 for sending the first message and the means 307 for receiving, in reply, the second message are configured, in this example, to communicate with the target network access node (tDU) 204_2.

The CU 202 sends an identification of the serving DU 204_1 (sDU) for UE 110 to the target DU 204_2 (tDU) for UE 110 to enable, at the target DU 204_2, selection of a sub-set of CFRA resources based on the received identification 304 of the serving DU 204_1. The selection associates the selected sub-set of contention-free-random-access (CFRA) resources with the identified serving network access node (serving DU 204_1).

The sub-set of CFRA resources can, for example, be DU-specific and specific to the identified serving DU 204_1 (sDU).

The sub-set of contention-free-random-access (CFRA) resources for the serving network access node (sDU) is contention-free with respect to other different network access nodes (DUs).

The first message 302 is configured to prepare the non-serving network access node 204_2 (tDU) to become a serving network access node (sDU) for a UE 110 via contention-free-random-access (CFRA) connection using a contention-free-random-access (CFRA) resource selected from the sub-set of a contention-free-random-access (CFRA) resources associated with the serving access node of the UE.

It will be appreciated that the means for sending the first message 302 and the means for receiving, in reply, the second message 321 are configured to communicate with a target network access node (tDU) to enable the target network access node (tDU) to become a serving network access node for a UE 110 via contention-free-random-access (CFRA) connection using a contention-free-random-access (CFRA) resource selected from the sub-set of contention-free-random-access (CFRA) resources associated with the serving access node of the UE 110.

The sub-set of contention-free-random-access (CFRA) resources is reserved for the connection of any UE, currently served by the identified serving access node (sDU), to the target network access node 204_2 (tDU) as a serving network access node.

The association of the sub-set of contention-free-random-access (CFRA) resources with a different serving network access node for the connection of a UE served by the different serving access node to the target network access node as a serving network access node, is prevented.

One way of maintaining, contention free random access, is to identify the sub-set of contention-free-random-access (CFRA) resources to only the identified serving network access node (sDU) and no other network access node.

Referring to FIG. 4, the UE 110 communicates 311 with its serving DU 204_1 (sDU). The UE 110 can, for example, send a measurement report to the serving DU 204_1 (sDU) which sends a trigger 313 to the CU 202. The CU 202 sends 321 a sub-set 604 of CFRA resources to the source DU 204_1. The source DU 204_1 (sDU) selects a CFRA resource from the received sub-set 604 of CFRA resources. The source DU 204_1 (sDU) identifies 330 the selected CFRA resource 602 to the UE 110. The UE 110 uses the received selected CFRA resource 602 to make a random access 910 to the connection to the target DU 204_2 (tDU) to enable handover of the UE 110 from the serving DU 204_1 (sDU) to the target DU 204_2 (tDU).

The sub-set 604 of CFRA resources sent to the source DU 204_1 (sDU) is specific for that DU. It is obtained by:

The central unit (CU) 202 sends a first message 302 comprising an identification 304 of the serving DU 204_1 (sDU) of the UE 110 to the target DU 204_2 (tDU).

The target DU 204_2 (tDU) uses the received an identification 304 of the serving DU 204_1 (sDU) to associate a sub-set 604 of contention-free-random-access (CFRA) resources with the identified serving DU (sDU) 2304_1.

The target DU 204_2 (tDU) sends to the CU 202, in reply to the first message 302, a second message 321 specifying the association of the sub-set 604 of contention-free-random-access (CFRA) resources with the identified serving DU 204_1 (sDU).

The CU 202 thus obtains in reply to sending the first message 302, a second message 321 specifying the association of the sub-set 604 of contention-free-random-access (CFRA) resources with the identified serving DU 204_1 (sDU).

Different sub-sets of CFRA resources, for random access to a target DU (tDU), can be associated with different respective serving DUs. In FIG. 5 a first UE 110_1 (UE1) is served by a serving DU 204-1 (sDU1) and uses a CFRA resource from a first sub-set 604_1 of CFRA resources for ransom access to the target DU 204_2 (tDU) and a a second UE 110_3 (UE2) is served by a serving DU 204_3 (sDU2) and uses a CFRA resource from a second sub-set 604_2 of CFRA resources for random access to the target DU 204_2 (tDU).

Referring to FIGS. 5, 6 and 7A, the first UE 110_1 (UE1) communicates 311_1 with its serving DU 204_1 (sDU1). The UE 110_1 can, for example, send a measurement report to the serving DU 204_1 (sDU1) which sends a trigger 313_1 to the CU 202.

The central unit (CU) 202 sends a first message 302_1 comprising an identification 304 of the serving DU 204_1 (sDU1) of the UE 110_1 to the target DU 204_2 (tDU).

The target DU 204_2 (tDU) uses the received identification of the serving DU 204_1 (sDU) to associate a first sub-set 604_1 of contention-free-random-access (CFRA) resources with the identified serving DU 204_1 (sDU).

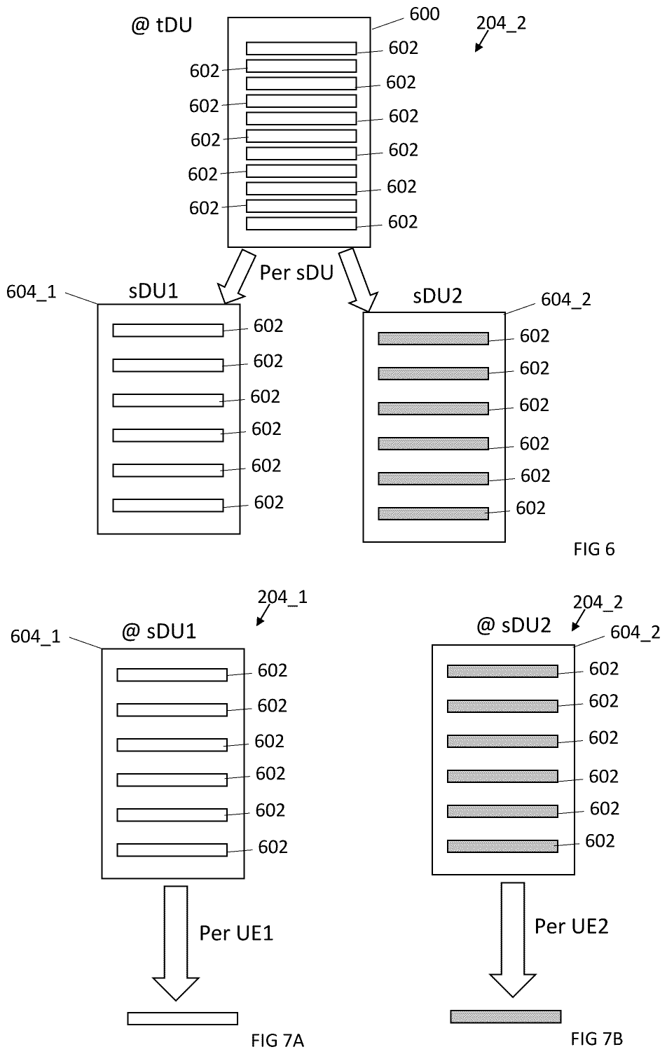

The target DU 204_2 (tDU) selects the first sub-set 604_1 of contention-free-random-access (CFRA) resources from a set 602 of contention-free-random-access (CFRA) resources 602 (FIG. 6).

The target DU 204_2 (tDU) sends to the CU 202, in reply to the first message 302_1, a second message 321_1 specifying the association of the first sub-set 604_1 of contention-free-random-access (CFRA) resources 602 with the identified serving DU 204_1 (sDU).

The CU 202 thus obtains, in reply to sending the first message 302_1 to the target DU 204_2 (tDU), from the target DU 204_2 (tDU), a first sub-set 604_1 of CFRA resources 602 specific for the serving DU 204_1 (sDU) of the UE 110_1.

The CU 202 sends the first sub-set 604_1 of CFRA resources 602 to the source DU 204_1 (sDU1).

The source DU 204_1 (sDU1) selects a CFRA resource 602 from the received first sub-set 604_1 of CFRA resources 602 (FIG. 7A).

The source DU 204_1 (sDU1) identifies 330 the selected CFRA resource 602 to the UE 110_1.

The UE 110_1 uses the received selected CFRA resource 602 to make a random-access connection 910_1 to the target DU 204_2 (tDU) to enable handover of the UE 110_1 from the serving DU 204_1 (sDU1) to the target DU 204_2 (tDU).

Referring to FIGS. 5, 6 and 7B, a second UE 110_3 (UE2) communicates 311_3 with its serving DU 204_3 (sDU2). The UE 110_3 can, for example, send a measurement report to the serving DU 204_3 (sDU2) which sends a trigger 313_3 to the CU 202.

The central unit (CU) 202 sends a second message 302_3 comprising an identification 304 of the serving DU 204_3 (sDU2) of the UE 110_3 to the target DU 204_2 (tDU).

The target DU 204_2 (tDU) uses the received identification of the serving DU 204_3 (sDU2) to associate a second sub-set 604_2 of contention-free-random-access (CFRA) resources with the identified serving DU 204_3 (sDU2).

The target DU 204_2 (tDU) selects a second sub-set 604_2 of contention-free-random-access (CFRA) resources from a set 602 of contention-free-random-access (CFRA) resources 602 (FIG. 6).

The target DU 204_2 (tDU) sends to the CU 202, in reply to the first message 302_3, a second message 321_3 specifying the association of the second sub-set 604_2 of contention-free-random-access (CFRA) resources 602 with the identified serving DU 204_3 (sDU2).

The CU 202 thus obtains, in reply to sending the first message 302_3 to the target DU 204_2 (tDU), from the target DU 204_2 (tDU), a second sub-set 604_2 of CFRA resources 602 specific for the serving DU 204_3 (sDU2) of the UE 110_3.

The CU 202 sends 323_3 the second sub-set 604_2 of CFRA resources 602 to the source DU 204_3 (sDU2). The source DU 204_3 (sDU2) selects a CFRA resource 602 from the received second sub-set 604_2 of CFRA resources 602 (FIG. 7B). The source DU 204_3 (sDU2) identifies 330 the selected CFRA resource 602 to the UE 110_3. The UE 110_3 uses the received selected CFRA resource 602 to make a random-access connection 910_3 to the target DU 204_2 (tDU) to enable handover of the UE 110_3 from the serving DU 204_3 (sDU2) to the target DU 204_2 (tDU).

The first subset 604_1 for serving DU 204_1 (sDU1) and the second sub-set 604_2 for serving DU 204_3 (sDU2) are different sub-sets comprising or consisting of different CFRA resources 602.

The first subset 604_1 for serving DU 204_1 (sDU1) and the second sub-set 604_2 for serving DU 204_3 (sDU2) can, for example, be non-overlapping sub-sets where no CFRA resource 602 that is a member of the first sub-set 604_1 is a member of the second sub-set 604_2.

The first subset 604_1 for serving DU 204_1 (sDU1) and the second sub-set 604_2 for serving DU 204_3 (sDU2) can, for example, be orthogonal sub-sets. Two resources are orthogonal if transmissions on both resources does not cause interference to each other. For example, different time occasions, or different frequency domain resources, or different spatial resources (e.g., beams) or different sequences satisfying orthogonality.

In the example illustrated, a first message 302_1 comprises an identification of the DU 204_1 (sDU1) that enables association of the first sub-set 604_1 of contention-free-random-access (CFRA) resources 602 with the identified DU 204_1 and a separate first message 302_2 comprises an identification of the DU 204_3 (sDU2) that enables association of the second sub-set 604_2 of contention-free-random-access (CFRA) resources 602 with the identified DU 204_3. However, in other examples, a single first message 302 can comprise an identification of the DU 204_1 (sDU1) that enables association of the first sub-set 604_1 of contention-free-random-access (CFRA) resources 602 with the identified DU 204_1 and an identification of the DU 204_3 (sDU2) that enables association of the second sub-set 604_2 of contention-free-random-access (CFRA) resources 602 with the identified DU 204_3.

In the example illustrated, the target DU 204_2 (tDU) sends to the CU 202 a second message 321_1 specifying the association of the first sub-set 604_1 of contention-free-random-access (CFRA) resources 602 with the identified serving DU 204_1 (sDU1) and sends separately to the CU 202 a second message 321_3 specifying the association of the second sub-set 604_2 of contention-free-random-access (CFRA) resources 602 with the identified serving DU 204_3 (sDU2). However, in other examples, the target DU 204_2 (tDU) sends to the CU 202 a second message 321 specifying the association of the first sub-set 604_1 of contention-free-random-access (CFRA) resources 602 with the identified serving DU 204_1 (sDU1) and specifying the association of the second sub-set 604_2 of contention-free-random-access (CFRA) resources 602 with the identified serving DU 204_3 (sDU2).

In the example illustrated, the CU 202 identifies sub-sets 604_1, 604_2 of CFRA resources 602 to respective serving network access nodes (sDU1, sDU2) based on replies 321_1, 321_3 to sent identifications of the serving network access nodes (sDu1, sDU2).

The first sub-set 604_1 of contention-free-random-access (CFRA) resources 602 are used for the connection of a UE 110_1 served by the DU 204_1 (sDU1) to a target DU 204_2 (tDU) as a serving network access node.

The second sub-set 604_2 of contention-free-random-access (CFRA) resources 602 are used for the connection of a UE 110_2 served by the DU 204_3 (sDU2) to the target DU 204_2 (tDU) as a serving network access node.

The first sub-set 604_1 of contention-free-random-access (CFRA) resources 602 are not used for the connection of the UE 110_2 served by the DU 204_3 (sDU2) to the target DU 204_2 (tDU) as a serving network access node.

The second sub-set 604_2 of contention-free-random-access (CFRA) resources 602 are not used for the connection of the UE 110_1 served by the DU 204_1 (sDU1) to the target DU 204_2 (tDU) as a serving network access node.

The target DU 204_2 (tDU) comprises means for allocating sub-sets 604_1, 604_2 of CFRA resources 602 to respective serving network access nodes (sDU1, sDu2). This allocation by the target DU 204_2 (tDU) associates sub-sets 604 of CFRA resources 602 with respective serving network access nodes (DUs) based on received identifications of a serving network access nodes (DUs). The first sub-set 604_1 of CFRA resources 602 is associated with the DU 204_1 (sDU1). The second sub-set 604_2 of CFRA resources 602 is associated with the DU 204_3 (sDU2).

The target DU 204_2 (tDU) comprises means for storing the sub-sets 604 of CFRA resources 602 associated with respective serving network access nodes (sDUs).

The target DU 204_2 (tDU) comprises means for informing the network (CU 202) of the allocation of sub-sets 604_1, 604_2 of CFRA resources 602 to respective serving network access nodes (sDU1, sDU2)

The target DU 204_2 (tDU) comprises means for enabling contention-free-random-access by reserving the first sub-set 604_1 of contention-free-random-access (CFRA) resources 602 for association with only the DU 204_1 (sDu1) and no other DU and reserving the second sub-set 604_1 of contention-free-random-access (CFRA) resources 602 for association with only the DU 204_3 (sDU2) and no other DU.

The reservation can be temporary. In this example, the target DU 204_2 (tDU) comprises means for temporarily reserving the first sub-set 604_1 of contention-free-random-access (CFRA) resources 602 for the connection of any UE currently served by the identified serving access node 204_1 (sDU1) to the target DU 204_2 (tDU) as a serving network access node. Association of the first sub-set 604_1 of contention-free-random-access (CFRA) resources 602 with a different serving network access node (sDU2, or others) is prevented. The target DU 204_2 (tDU) also comprises means for temporarily reserving the second sub-set 604_2 of contention-free-random-access (CFRA) resources 602 for the connection of any UE currently served by the identified serving access node 204_3 (sDU2) to the target DU 204_2 (tDU) as a serving network access node. Association of the second sub-set 604_2 of contention-free-random-access (CFRA) resources 602 with a different serving network access node (sDU1, or others) is prevented.

FIG. 8 illustrates an example of a message 302 for providing an identification 304 of a serving network access node.

The message 302 is a standardized message comprising standardized information elements 802.

The message 302 is processed by the target DU 204_2 to obtain from a standardized information element 802_1 the identification 304 of the serving network access node e.g. sDU1 or sDU2.

In at least some examples, the message is a UE Context Setup REQUEST message.

In at least some examples, the message is received by the target DU 204_2 (tDU) from the CU 202 over a F1 interface.

Although preceding examples, use a split architecture using a central unit CU 202 and distributed units 204, other examples can use other architectures.

Although preceding examples, use a split architecture using a central unit CU 202 and distributed units 204 where there is no direct DU to DU communication, other examples could use other architectures where there is direct DU to DU communication. The identification of the serving DU can then be provided directly to the target DU (without going via the CU). The sub-set of CFRA resources can then be provided directly to the serving DU by the target DU (without going via the CU).

Although the following examples, use contention free random access as a part of lower layer triggered mobility (LTM) handover (HO), the CFRA resources can be used for any random-access procedure.

Lower layer triggered mobility (LTM) is a lower layer procedure i.e. below layer 3 and is performed by a DU 204.

The user equipment 110 can, for example, enable low-latency triggered mobility (LTM) that enables a serving cell change (handover) via low-latency signaling e.g. below layer three. The latency in handover once triggered can, for example, be less that 10 ms.

LTM is a procedure in which a network node (e.g. DU 202) receives measurement reports from UEs 110, and on their basis, the network node controls a change in UEs' serving cell(s) through a MAC CE. The network node prepares one or multiple candidate cells and provides the cell-change configuration for the prepared candidate cells to the UE. Then LTM cell switch is triggered, by selecting one of the cell-change configuration as target configuration for LTM. The trigger for selection can be at the network node (normal handover) or can be at the user equipment (conditional handover). The cell-change configuration can, for example, define information for use in a Random Access procedure 910 for connecting to a new cell. A cell-change configuration can be provided as a delta configuration (that is change relative to a reference configuration) or as a full explicit cell-change configuration.

The distributed unit 204_2 (tDU) is configured for lower layer trigger mobility (LTM) handover (HO) of a user equipment 110_1 (UE1) served by the serving DU 204_1 (sDU1) to the distributed unit 204_2 (tDU) using a random-access procedure 910_1 based on a contention-free-random-access (CFRA) resource from the first sub-set 604_1 of contention-free-random-access (CFRA) resources 602 associated with the serving DU 204_1 (sDU1)

The distributed unit 204_2 (tDU) is configured for lower layer trigger mobility (LTM) handover (HO) of a user equipment 110_2 (UE2) served by the serving DU 204_3 (sDU2) to the distributed unit 204_2 (tDU) using a random-access procedure 910_3 based on a contention-free-random-access (CFRA) resource from the second sub-set 604_2 of contention-free-random-access (CFRA) resources 602 associated with the serving DU 204_3 (sDU2)

In FIG. 9A, random access 910 using the a CFRA resource 602 selected from a sub-set of CFRA resources is during a preparation phase 902 of the LTM 900 that precedes an execution phase 904. The execution phase is triggered 904. This is early synchronization for early timing advance acquisition.

In FIG. 9B, random access 910 using the a CFRA resource 602 selected from a sub-set of CFRA resources is during an execution phase 906 of the LTM 900 that follows a preparation phase 902 of the LTM 900. The execution phase is triggered 904

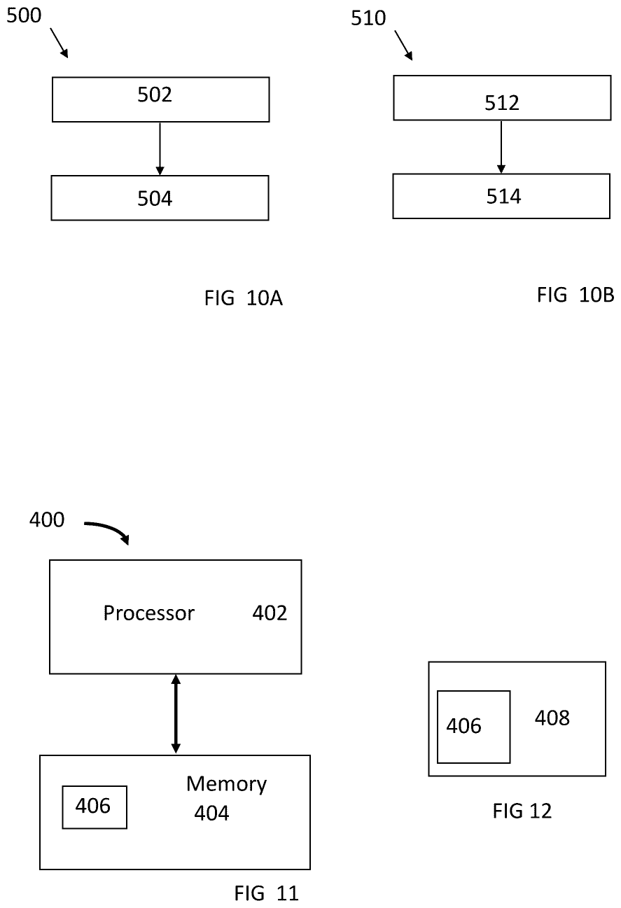

FIG. 10A illustrates an example of a method 500. The method 500 can, for example, be performed by a distributed unit 204 (DU) operating as a target distributed unit (tDU).

The method 500 comprises at block 502, receiving an identification of a serving network access node (sDU).

The method 500 comprises at block 504, associating a sub-set 604 of contention-free-random-access (CFRA) resources 602 with the identified serving network access node (sDU).

FIG. 10B illustrates an example of a method 510. The method 510 can, for example, be performed by a central unit 202 (CU) communicating with a target distributed unit (tDU).

The method 510 comprises at block 512, sending a first message comprising an identification of a serving network access node (sDU) to enable association of a sub-set 604 of contention-free-random-access (CFRA) resources 602 with the identified serving network access node (sDU).

The method 510 comprises at block 514, receiving, in reply, a second message specifying the association of the sub-set 604 of contention-free-random-access (CFRA) resources 602 with the identified serving network access node (sDU).

FIG. 11 illustrates an example of a controller 400 suitable for use in an apparatus such as a network apparatus 202, 204. Implementation of a controller 400 may be as controller circuitry. The controller 400 may be implemented in hardware alone, have certain aspects in software including firmware alone or can be a combination of hardware and software (including firmware).

As illustrated in FIG. 11 the controller 400 may be implemented using instructions that enable hardware functionality, for example, by using executable instructions of a computer program 406 in a general-purpose or special-purpose processor 402 that may be stored on a computer readable storage medium (disk, memory etc) to be executed by such a processor 402.

The processor 402 is configured to read from and write to the memory 404. The processor 402 may also comprise an output interface via which data and/or commands are output by the processor 402 and an input interface via which data and/or commands are input to the processor 402.

The memory 404 stores a computer program 406 comprising computer program instructions (computer program code) that controls the operation of the apparatus 202, 204 when loaded into the processor 402. The computer program instructions, of the computer program 406, provide the logic and routines that enables the apparatus to perform the methods illustrated in the accompanying Figs. The processor 402 by reading the memory 404 is able to load and execute the computer program 406.

The apparatus 202 comprises:
at least one processor 402; and
   at least one memory 404 including computer program code,
   the at least one memory storing instructions that, when executed by the at least one processor 402, cause the apparatus 202 at least to:
send a first message comprising an identification of a serving network access node (sDU) to enable association of a sub-set of contention-free-random-access (CFRA) resources with the identified serving network access node (sDU); and
receive, in reply, a second message specifying the association of the sub-set of contention-free-random-access (CFRA) resources with the identified serving network access node (sDU).

The apparatus 204 comprises:
at least one processor 402; and
   at least one memory 404 including computer program code,
   the at least one memory storing instructions that, when executed by the at least one processor 402, cause the apparatus 204 at least to:
receiving an identification of a serving network access node; and
associating a sub-set of contention-free-random-access (CFRA) resources with the identified serving network access node.

As illustrated in FIG. 12, the computer program 406 may arrive at the apparatus 202, 204 via any suitable delivery mechanism 408. The delivery mechanism 408 may be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 406. The delivery mechanism may be a signal configured to reliably transfer the computer program 406. The apparatus 202, 204 may propagate or transmit the computer program 406 as a computer data signal.

Computer program instructions for causing an apparatus 202 to perform at least the following or for performing at least the following:
sending a first message comprising an identification of a serving network access node (sDU) to enable association of a sub-set of contention-free-random-access (CFRA) resources with the identified serving network access node (sDU) to receive in reply a second message specifying the association of the sub-set of contention-free-random-access (CFRA) resources with the identified serving network access node (sDU).

Computer program instructions for causing an apparatus 204 to perform at least the following or for performing at least the following:
obtaining an identification of a serving network access node from a received message; and
associating a sub-set of contention-free-random-access (CFRA) resources with the obtained identification of the serving network access node.

The computer program instructions may be comprised in a computer program, a non-transitory computer readable medium, a computer program product, a machine readable medium. In some but not necessarily all examples, the computer program instructions may be distributed over more than one computer program.

Although the memory 404 is illustrated as a single component/circuitry it may be implemented as one or more separate components/circuitry some or all of which may be integrated/removable and/or may provide permanent/semi-permanent/dynamic/cached storage.

Although the processor 402 is illustrated as a single component/circuitry it may be implemented as one or more separate components/circuitry some or all of which may be integrated/removable. The processor 402 may be a single core or multi-core processor.

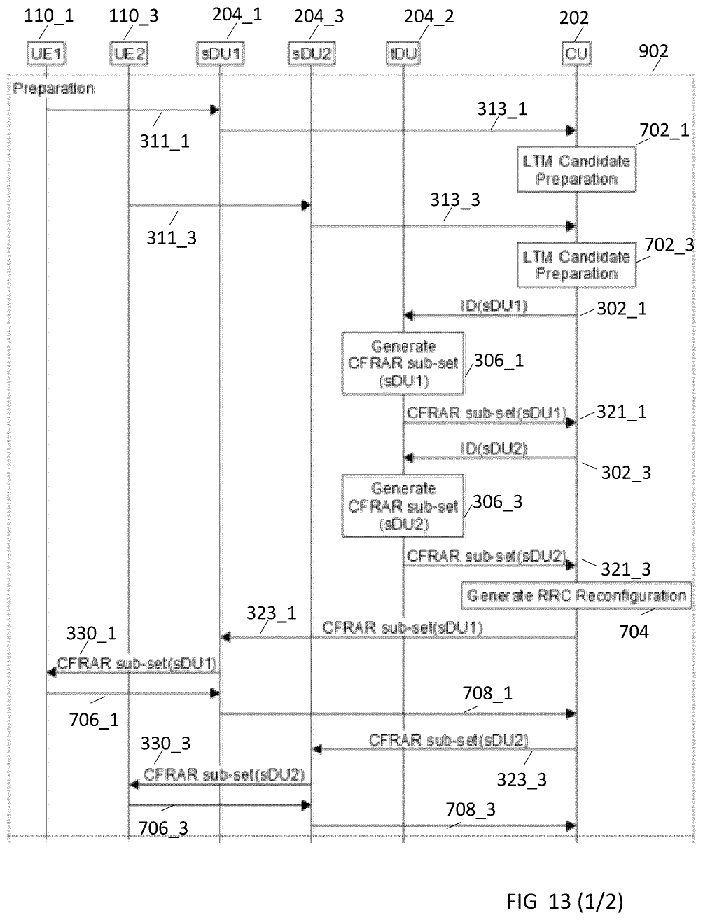

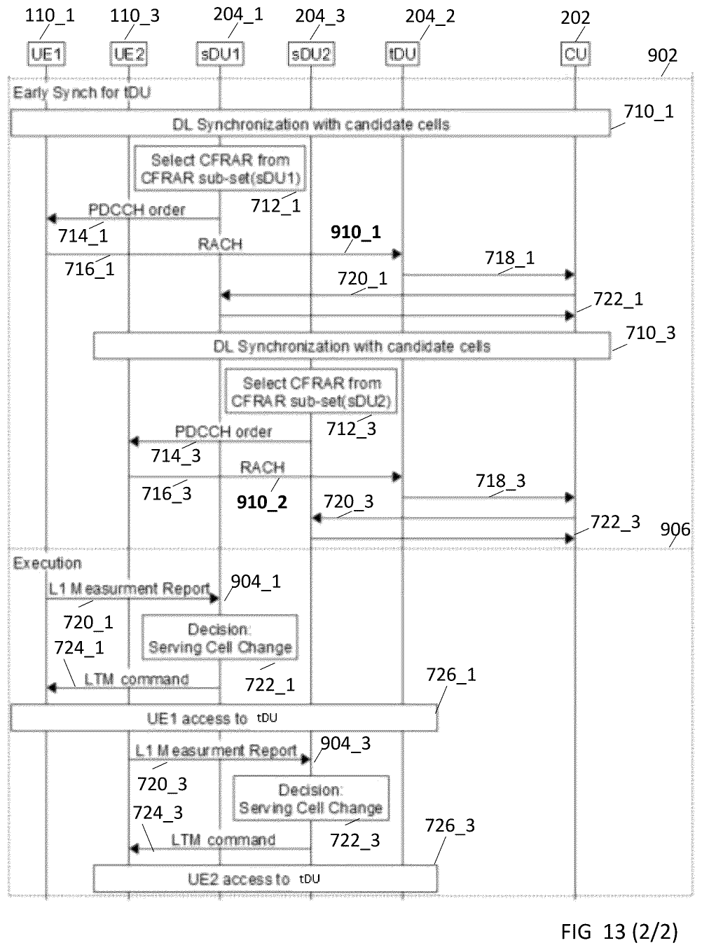

FIG. 13 is an example of FIG. 5 for LTM using early synchronization (FIG. 9A) and similar references are used for similar features.

The UE1 110_1 is served by a cell under the source DU1 204_1. The UE2 110_3 is served by a cell under the source DU2 204_3. The target cell is under the target DU 204_2 (tDU).

A target DU and a source DU can be the same entity (i.e., both serving and target cell can be under the same DU). The target DU and a source DU can be different entities (i.e., serving and target cell can be under the different DU). In the latter inter-DU scenario, the target DU and a source DU can be under control of the same CU or the target DU and a source DU can be under control of different CUs.

The LTM process 900 illustrated has a preparation phase 902 and an execution phase 906. The execution phase is caused by trigger 904.

Random access 910 using the a CFRA resource 602 selected from a sub-set of CFRA resources occurs during the preparation phase 902 of the LTM 900 that precedes the execution phase 904. This is early synchronization for early timing advance acquisition.

The UE1 110_1 sends a L3 Measurement Report message 311_1, 313_1 to the CU 202 via the Source DU 204_1 (sDU1) (The sDU1 204_1 sends UL RRC MESSAGE TRANSFER Message 313_1 comprising the L3 Measurement Report to CU 202). The CU 202 decides to use LTM and initiates LTM candidate cells preparation 702_1.

The CU 202 sends a UE context setup request 302_1 to the target DU 204_2 (tDU) for the preparation of the target cells. The message 302_1 comprises an identification of the serving DU 204_1 (sDU1) to enable association of a sub-set 604 of contention-free-random-access (CFRA) resources 602 with the identified serving DU 204_1 (sDU1).

The target DU 204_2 (tDU) receives the message 302_1 comprising the identification of the serving DU 204_1 (sDU1). In this example, the message 302_1 is a UE CONTEXT SETUP REQUEST 302_1 comprising gNB-DU ID of serving cell, e.g., ID of source DU 204_1 (sDU1).

The target DU 204_2 (tDU) associates 306_1 a first sub-set 604_1 of contention-free-random-access (CFRA) resources 602 with the identified serving DU 204_1 (sDU1). The target DU 204_2 (tDU) can for example generate 306_1 a CFRA Resources sub-set 604_1 for sDU1 and the first sub-set 604_1 of CFRA resources 602 is allocated to source sDU1 204_1.

The target DU 204_2 (tDU) then sends a message 321_1 specifying the association of the first sub-set 604_1 of contention-free-random-access (CFRA) resources 602 with the identified serving DU 204_1 (sDU1). In this example, the message 321_1 is a UE CONTEXT SETUP RESPONSE Message 321_1 including the first sub-set 604_1 of CFRA resources 602.

The CU 202 receives the message 321_1 specifying the association of the first sub-set 604_1 of contention-free-random-access (CFRA) resources 602 with the identified serving DU 204_1 (sDU1).

The CU 202 prepares 704 the RRC Configuration and provides it 323_1, 330_1 to the UE 110_1 (UE1) via the source DU 204_1 (sDU1). In this example, the message 323_1 from CU 202 to sDU1 204_1 is a DL RRC MESSAGE TRANSFER Message 323_1 that includes the first sub-set 604_1 of CFRA resources 602. The message 330_1 from the sDU1 204_1 to the UE1 110_1 is a RRC Reconfiguration message 330_1 including the first sub-set 604_1 of CFRA resources 602.

The UE 110_1 (UE1) stores the configuration of LTM candidate target cell(s) and transmits a RRC Reconfiguration Complete message 706_1, 708_1 to the CU 202 via the source DU 204_1 (sDU1). The message 706_1 from UE1 110_1 to sDU1 204_1 is a RRC Reconfiguration Complete message. The message 708_1 from sDU1 204_1 to CU 202 is a UL RRC MESSAGE TRANSFER message 708_1.

The UE 110_1 (UE1) may perform DL early synchronization and early TA acquisition with candidate target cell(s) before receiving the LTM cell switch command 724_1.

The early timing advance (TA) acquisition steps are:

Once Source DU 204_1 (sDU1) decides to trigger PRACH signal transmission from UE1 110_1 towards Target DU 204_2 (tDU), it selects 712_1 a CFRA resource 602 from the first sub-set 604_1 of CFRA resources 602.

It then sends PDCCH order 714_1 to the UE1 110_1. The PDCCH order 714_1 contains the relevant configuration information (e.g., preamble id, SS/PBCH index, RACH occasion etc.) which includes the selected UE-specific CFRA resource 602.

The source DU 204_1 (sDU1) marks the UE-specific CFRA resource 602 as ‘reserved’ until the UE 110_1 (UE1) completes random access using the UE-specific CFRA resource 602 or there is a release of the UE-specific CFRA resource.

Based on the information received, the UE 110_1 (UE1) triggers random access procedure 910_1 towards the target DU 204_2 (tDU), that is, the preamble transmission 716_1 over PRACH (i.e., physical random access channel) of the target DU 204_2 (tDU).

After acquiring the timing advance (TA) relevant to the UE 110_1 (UE1), the target DU 204_2 (tDU) provides 718_1, 720_1 the TA value for LTM handover for the target cell together with other relevant information (e.g., preamble id, SS/PBCH index, RACH occasion etc.) to the source DU 204_1 (sDU1) via the CU 202. The source DU 204_1 (sDU1) can now associate the received TA value to the particular UE 110_1 (UE1).

In this example, the message 720_1 is a UE CONTEXT MODIFICATION REQUEST 720_1 indicating acquired TA value for target cell). The sDU1 204_1 responds with UE CONTEXT MODIFICATION RESPONSE 722_1.

The execution phase is triggered 904_1 by lower layer measurement report 720_1 sent from the UE1 110_1 to the serving DU 204_1 (sDU1). The UE 110_1 (UE1) performs L1 measurements on the configured LTM candidate target cell(s), and transmits lower-layer measurement reports 904_1 to the source DU 204_1 (sDU1).

The source DU 204_1 (sDU1) decides 722_1 to execute LTM cell switch to a target cell (tDU 204_2), and transmits a LTM Command 724_1 (a MAC CE) to the UE 110_1 (UE1) triggering LTM cell switch at the UE 110_1 (UE1).

The UE 110_1 (UE1) switches to the configuration of the LTM candidate target cell (tDU 204_2) and accesses 726_1 the target cell. If needed (i.e., if timing advance is not available/valid), it performs Random Access (not illustrated).

The UE 110_1 (UE1) can indicate successful completion of the LTM cell switch towards target cell using an RRC Reconfiguration complete.

The UE2 110_3 sends a L3 Measurement Report message 311_3, 313_3 to the CU 202 via the Source DU 204_3 (sDU2) (The sDU2 204_3 sends UL RRC MESSAGE TRANSFER Message 313_3 comprising the L3 Measurement Report to CU 202). The CU 202 decides to use LTM and initiates LTM candidate cells preparation 702_3.

The CU 202 sends a UE context setup request 302_3 to the target DU 204_2 (tDU) for the preparation of the target cells. The message 302_3 comprises an identification of the serving DU 204_3 (sDU2) to enable association of a sub-set of contention-free-random-access (CFRA) resources 602 with the identified serving DU 204_3 (sDU2).

The target DU 204_2 (tDU) receives the message 302_3 comprising the identification of the serving DU 204_3 (sDU2). In this example, the message 302_3 is a UE CONTEXT SETUP REQUEST 302_3 comprising gNB-DU ID of serving cell, e.g., ID of source DU 204_3 (sDU2).

The target DU 204_2 (tDU) associates 306_3 a second sub-set 604_2 of contention-free-random-access (CFRA) resources 602 with the identified serving DU 204_3 (sDU2). The target DU 204_2 (tDU) can for example generate 306_3 a CFRA Resources sub-set 604_2 for sDU2 and the second sub-set 604_2 of CFRA resources 602 is allocated to source DU 204_3 (sDU2).

The target DU 204_2 (tDU) then sends a message 321_3 specifying the association of the second sub-set 604_2 of contention-free-random-access (CFRA) resources 602 with the identified serving DU 204_3 (sDU2). In this example, the message 321_3 UE CONTEXT SETUP RESPONSE Message 321_3 includes the second sub-set 604_2 of CFRA resources 602.

The CU 202 receives the message 321_3 specifying the association of the second sub-set 604_2 of contention-free-random-access (CFRA) resources 602 with the identified serving DU 204_3 (sDU2).

The CU 202 prepares 704 the RRC Configuration and provides it 323_3, 330_3 to the UE 110_3 (UE2) via the source DU 204_3 (sDU2). In this example, the message 323_3 from CU 202 to sDU2 204_3 is a DL RRC MESSAGE TRANSFER Message 323_3 that includes the second sub-set 604_2 of CFRA resources 602. The message 330_3 from the sDU2 204_3 to the UE2 110_3 is a RRC Reconfiguration message 330_3 including the second sub-set 604_2 of CFRA resources 602.

The UE 110_3 (UE2) stores the configuration of LTM candidate target cell(s) and transmits a RRC Reconfiguration Complete message 706_3, 708_3 to the CU 202 via the source DU 204_3 (sDU2). The message 706_3 from UE2 110_3 to sDU2 204_3 is a RRC Reconfiguration Complete message. The message 708_3 from sDU2 204_3 to CU 202 is a UL RRC MESSAGE TRANSFER message 708_3.

The UE 110_3 (UE2) may perform DL early synchronization and early TA acquisition with candidate target cell(s) before receiving the LTM cell switch command 724_3.

The early timing advance (TA) acquisition steps are:

Once source DU 204_3 (sDU2) decides to trigger PRACH signal transmission from UE2 110_3 towards Target DU 204_2 (tDU), it selects 712_3 a CFRA resource 602 from the second sub-set 604_2 of CFRA resources 602.

It then sends PDCCH order 714_3 to the UE2 110_3. The PDCCH order 714_3 contains the relevant configuration information (e.g., preamble id, SS/PBCH index, RACH occasion etc.) which includes the selected UE-specific CFRA resource 602.

The source DU 204_3 (sDU2) marks the UE-specific CFRA resource as ‘reserved’ until the UE 110_3 (UE2) completes random access using the UE-specific CFRA resource 602 or there is a release of the UE-specific CFRA resource 602.

Based on the information received, the UE 110_3 (UE2) triggers random access procedure 910_3 towards the target DU 204_2 (tDU), that is, the preamble transmission 716_3 over PRACH (i.e., physical random access channel) of the target DU 204_2 (tDU).

After acquiring the timing advance (TA) relevant to the UE 110_3 (UE2), the target DU 204_2 (tDU) provides 718_3, 720_3 the TA value for LTM handover for the target cell together with other relevant information (e.g., preamble id, SS/PBCH index, RACH occasion etc.) to the source DU 204_3 (sDU2) via the CU 202. The source DU 204_3 (sDU2) can now associate the received TA value to the particular UE 110_3 (UE2). In this example, the message 720_3 is a UE CONTEXT MODIFICATION REQUEST 720_3 indicating acquired TA value for target cell). The sDU2 204_3 responds with UE CONTEXT MODIFICATION RESPONSE 722_3.

The execution phase is triggered 904_3 by lower layer measurement report 720_3 sent from the UE2 110_3 to the serving DU 204_3 (sDU2). The UE 110_3 (UE2) performs L1 measurements on the configured LTM candidate target cell(s), and transmits lower-layer measurement reports 904_3 to the source DU 204_3 (sDU2).

The source DU 204_3 (sDU2) decides 722_3 to execute LTM cell switch to a target cell (tDU 204_2), and transmits a LTM Command 724_3 (a MAC CE) to the UE 110_3 (UE2) triggering LTM cell switch at the UE 110_3 (UE2).

The UE 110_3 (UE2) switches to the configuration of the LTM candidate target cell (tDU 204_2) and accesses 726_3 the target cell. If needed (i.e., if timing advance is not available/valid), it performs Random Access (not illustrated).

The UE 110_3 (UE2) can indicate successful completion of the LTM cell switch towards target cell using an RRC Reconfiguration complete.

The above processes avoids PRACH collision in case CFRA resources are shared among UEs connected to different DUs. It prevents source DUs using the same CFRA resource for different UEs which may result in PRACH collision.

A CFRA resource pool (sub set 604) is configured per DU. This prevents a CFRA resource being shared by UEs belonging to different source Dus.

The process avoids CFRA resource starvation problem in dense environment, enables low latency handover by avoiding RACH collisions (HO failures) and enables shared CFRA resource for early TA acquisition.

According to an example, the first sub-set 604_1 of CFRA resources 602 of a target cell belonging to a target DU 204_2 (tDU) is shared among all the UEs 110 in source cells belonging to the first source DU 204_1 (sDU1), and a second sub-set of CFRA resources 604_2 of the target cell belonging to the target DU 204_2 (tDU) is shared among all the UEs in the source cells belonging to a second source DU 204_3 (sDU2).

In some examples, the first sub-set 604_1 of CFRA resources 602 of a target cell is orthogonal to the second sub-set 604_2 of CFRA resources 602 of the target cell. In other words, orthogonal sub-sets of CFRA resources 602 of a target cell are configured to UEs in source cells belonging to different source DUs 204.

According to some examples, an identity of a first source DU 204_1 (sDU1) and/or second source DU 204_3 (sDU2) are/is provided to the target DU 204_2 (tDU) by the CU 202.

According to some examples, an identity of a first source DU 204_1 (sDU1) and/or second source DU 204_3 (sDU2) are/is provided to the target DU 204_2 (tDU) by the CU 202 as part of UE CONTEXT SETUP REQUEST message(s).

According to examples an identity of a first source DU 204_1 (sDU1) and/or second source DU 204_3 (sDU2) are/is provided to the target DU 204_2 (tDU) by the CU 202 as part of UE CONTEXT MODIFICATION REQUEST message(s).

According to examples, an identity of a first source DU 204_1 (sDU1) and/or second source DU 204_3 (sDU2) are/is provided to the target DU 204_2 (tDU) by the CU 202 as part of a new message over the F1 interface.

According to examples, the target DU 204_2 (tDU) allocates a first sub-set 604_1 of CFRA resources to the first source DU 204_1 (sDU1) and a second sub-set 604_2 of CFRA resources to the second source DU 204_3 (sDU2).

According to examples, the first sub-set 604_1 of CFRA resources are fully or partially orthogonal to second set of CFRA resources.

According to examples, the first sub-set 604_1 of CFRA resources are the same as the second sub-set 604_2 of CFRA resources, however, the first and second sub-set 604_2s of CFRA resources are orthogonal to a third sub-set of CFRA resources which is shared among all the UEs in source cells belonging to a third source DU.

According to examples, the CU 202 allocates the first sub-set 604_1 of CFRA resources to the first source DU 204_1 (sDU1) and a second sub-set 604_2 of CFRA resources to the second source DU 204_3 (sDU2).

According to examples, both first and second sub-set 604_2 of CFRA resources are a subset of total amount of CFRA resources provided by the target DU 204_2 (tDU) for a target cell.

According to examples, if another UE of the first source DU 204_1 (sDU1) requires the LTM preparation for the cell belonging to the same target DU 204_2 (tDU), the target DU 204_2 (tDU) provides the first sub-set 604_1 of CFRA resources. Similarly, if another UE of the second source DU 204_3 (sDU2) requires the LTM preparation for the cell belonging to the same target DU 204_2 (tDU), the target DU 204_2 (tDU) provides the second set of CFRA resources.

According to examples, a target DU 204_2 (tDU) reserves the set of CFRA resources as long as there is at least one UE that is prepared with LTM with a candidate target cell belonging to the target DU 204_2 (tDU).

According to examples, the target DU 204_2 (tDU) will release the CFRA resources reserved for a source DU if UE context release is performed for all the UEs of the source DU in the target DU 204_2 (tDU).

According to examples, the target DU 204_2 (tDU) will release the CFRA resources if an explicit indication is received from the CU 202.

According to examples, a new procedure is introduced which allow efficient signaling by separately requesting CFRA resource pools from the target DU 204_2 (tDU) for multiple source DUs. In this case, a list of source DUs are indicated in the CFRA Resource Request message and a list of sets of CFRA resource pools are indicated in the CFRA Response message.

Referring to FIGS. 8 and 13, the message 302 can be a UE CONTEXT SETUP message. An exemplary structure of a UE CONTEXT SETUP REQUEST message in 3GPP TS 38.473:

| | | IE type and | | Assigned |
|---|---|---|---|---|
| IE/Group Name | Presence | reference | Criticality | Criticality |
| Message Type | M | 9.3.1.1 | YES | reject |
| gNB-CU UE F1AP ID | M | 9.3.1.4 | YES | reject |
| gNB-DU UE F1AP ID | O | 9.3.1.5 | YES | ignore |
| LTM source DU | O | | YES | ignore |
| information | | | | |
| >gNB-DU ID | M | 9.3.1.9 | — | |
| SpCell ID | M | NR CGI | YES | reject |
| | | 9.3.1.12 | | |
| ServCellIndex | M | INTEGER | YES | reject |
| | | (0 . . . | | |
| | | 31, . . . ) | | |
| SpCell UL | O | Cell UL | YES | ignore |
| Configured | | Configured | | |
| | | 9.3.1.33 | | |
| CU to DU RRC | M | 9.3.1.25 | YES | reject |
| Information | | | | |

Remaining IEs of message are omitted for conciseness purpose

The message comprises a new information element <LTM source DU information>.

The new information element <LTM source DU information> comprises a new information element <gNB-DU ID>.

The new information element <gNB-DU ID> is the identification 304 of the serving network access node (sDU). It can be the gNB-DU ID of the serving cell, e.g., ID of source DU 204 (sDU.

The UE CONTEXT SETUP REQUEST message is sent by the gNB-CU to gNB-DU to request the setup of a UE context.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ may refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory or memories that work together to cause an apparatus, such as a mobile phone or server, to perform various functions and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The blocks illustrated in the accompanying Figs may represent steps in a method and/or sections of code in the computer program 406. The illustration of a particular order to the blocks does not necessarily imply that there is a required or preferred order for the blocks and the order and arrangement of the block may be varied. Furthermore, it may be possible for some blocks to be omitted.

Where a structural feature has been described, it may be replaced by means for performing one or more of the functions of the structural feature whether that function or those functions are explicitly or implicitly described.

As used here ‘module’ refers to a unit or apparatus that excludes certain parts/components that would be added by an end manufacturer or a user. The apparatus 202, 204 can be modules.

The above-described examples find application as enabling components of: automotive systems; telecommunication systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things; virtualized networks; and related software and services.

The apparatus can be provided in an electronic device, for example, a mobile terminal, according to an example of the present disclosure. It should be understood, however, that a mobile terminal is merely illustrative of an electronic device that would benefit from examples of implementations of the present disclosure and, therefore, should not be taken to limit the scope of the present disclosure to the same. While in certain implementation examples, the apparatus can be provided in a mobile terminal, other types of electronic devices, such as, but not limited to: mobile communication devices, hand portable electronic devices, wearable computing devices, portable digital assistants (PDAs), pagers, mobile computers, desktop computers, televisions, gaming devices, laptop computers, cameras, video recorders, GPS devices and other types of electronic systems, can readily employ examples of the present disclosure. Furthermore, devices can readily employ examples of the present disclosure regardless of their intent to provide mobility.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, the wording ‘connect’, ‘couple’ and ‘communication’ and their derivatives mean operationally connected/coupled/in communication. It should be appreciated that any number or combination of intervening components can exist (including no intervening components), i.e., so as to provide direct or indirect connection/coupling/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’, ‘an’ or ‘the’ is used in this document with an inclusive not an exclusive meaning. That is any reference to X comprising a/an/the Y indicates that X may comprise only one Y or may comprise more than one Y unless the context clearly indicates the contrary. If it is intended to use ‘a’, ‘an’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

I/We claim:

1. An apparatus comprising:
at least one processor; and
at least one memory including computer program code,
the at least one memory storing instructions that, when executed by the at least one processor, cause the apparatus at least to:
receive an identification of a serving network access node; and
associate a sub-set of contention-free-random-access (CFRA) resources with the identified serving network access node.

2. The apparatus as claimed in claim 1, wherein the at least one memory further stores instructions that, when executed by the at least one processor, cause the apparatus to enable contention-free-random-access by reserving the sub-set of contention-free-random-access (CFRA) resources for association with only the identified serving network access node and no other network access node.

3. The apparatus as claimed in claim 1, wherein the at least one memory further stores instructions that, when executed by the at least one processor, cause the apparatus to temporarily reserve the sub-set of contention-free-random-access (CFRA) resources for the connection of any UE currently served by the identified serving access node to the apparatus as a serving network access node, wherein association of the sub-set of contention-free-random-access (CFRA) resources with a different serving network access node is prevented.

4. The apparatus as claimed in claim 1, wherein the sub-set of contention-free-random-access (CFRA) resources for the serving network access node is contention-free with respect to other different network access nodes.

5. The apparatus as claimed in claim 1, wherein the at least one memory further stores instructions that, when executed by the at least one processor, cause the apparatus to associate sub-sets of CFRA resources with respective serving network access nodes based on received identifications of a serving network access nodes.

6. The apparatus as claimed in claim 1, wherein the at least one memory further stores instructions that, when executed by the at least one processor, cause the apparatus to:
allocate sub-sets of CFRA resources to respective serving network access nodes and
inform the network of the allocation of sub-sets of CFRA resources to respective serving network access nodes.

7. The apparatus as claimed in claim 5, wherein the sub-sets of CFRA resources comprises or consists of:
different sub-sets for different network access nodes; or
non-overlapping sub-sets for different network access nodes; or
orthogonal sub-sets for different network access nodes.

8. The apparatus as claimed in claim 1, configured for operation as a distributed unit (DU) of a radio access network.

9. The apparatus as claimed in claim 8, wherein the at least one memory further stores instructions that, when executed by the at least one processor, cause the apparatus to receive the identification of the serving network access node is configured to receive the identification of the serving network access node from a central unit (CU) of the radio access network.

10. The apparatus as claimed in claim 1, configured to process a standardized message comprising standardized information elements to obtain from a standardized information element the identification of the serving network access node.

11. The apparatus as claimed in claim 1, configured as a network access node and configured for lower layer trigger mobility (LTM) handover (HO) of a user equipment served by the serving network access node to the apparatus using a random-access procedure based on a contention-free-random-access (CFRA) resource from the sub-set of contention-free-random-access (CFRA) resources associated with the serving network access node.

12. A method comprising:
receiving an identification of a serving network access node; and
associating a sub-set of contention-free-random-access (CFRA) resources with the identified serving network access node.

13. An apparatus comprising:
at least one processor; and
at least one memory including computer program code,
the at least one memory storing instructions that, when executed by the at least one processor, cause the apparatus at least to:
send a first message comprising an identification of a serving network access node to enable association of a sub-set of contention-free-random-access (CFRA) resources with the identified serving network access node; and
receive, in reply, a second message specifying the association of the sub-set of contention-free-random-access (CFRA) resources with the identified serving network access node.

14. The apparatus as claimed in claim 13, wherein the first message is configured to prepare a non-serving network access node to become a serving network access node for a UE via contention-free-random-access (CFRA) connection using a contention-free-random-access (CFRA) resource selected from the sub-set of a contention-free-random-access (CFRA) resources associated with the serving access node of the UE.

15. The apparatus as claimed in claim 13, wherein the at least one memory further stores instructions that, when executed by the at least one processor, cause the apparatus to send one or more first messages comprising:
an identification of a first serving network access node to enable association of a first sub-set of contention-free-random-access (CFRA) resources with the identified first serving network access node; and
an identification of a second serving network access node to enable association of a second sub-set of contention-free-random-access (CFRA) resources with the identified second serving network access node.

16. The apparatus as claimed in claim 13, wherein the at least one memory further stores instructions that, when executed by the at least one processor, cause the apparatus to identify the sub-set of contention-free-random-access (CFRA) resources to only the identified serving network access node and no other network access node.

17. The apparatus as claimed in claim 13, wherein the at least one memory further stores instructions that, when executed by the at least one processor, cause the apparatus to enable temporary reservation of the sub-set of contention-free-random-access (CFRA) resources for the connection of any UE currently served by the identified serving access node to a target network access node as a serving network access node, wherein association of the sub-set of contention-free-random-access (CFRA) resources with a different serving network access node for the connection of a UE served by the different serving access node to the target network access node as a serving network access node, is prevented.

18. The apparatus as claimed in claim 13, wherein the at least one memory further stores instructions that, when executed by the at least one processor, cause the apparatus to identify sub-sets of CFRA resources to respective serving network access nodes based on replies to sent identifications of the serving network access nodes.

19. The apparatus as claimed in claim 13 configured as a central unit (CU) of a radio access network, wherein sending the identification of the serving network access node comprises sending the identification of the serving network access node to a distributed unit (DU) of the radio access network.
